(19) United States
(12) Patent Application Publication
(10) Pub. No.: US 2021/0300283 A1
(43) Pub. Date: Sep. 30, 2021

(54) FRONT PASSENGER SEAT AIRBAG

(71) Applicant: TOYODA GOSEI CO., LTD., Kiyosu-shi (JP)

(72) Inventors: Takuya HIRAIWA, Kiyosu-shi (JP); Shinichi ISHIDA, Kiyosu-shi (JP); Keita SUZUKI, Nagoya-shi (JP)

(21) Appl. No.: 17/216,054

(22) Filed: Mar. 29, 2021

(30) Foreign Application Priority Data
Mar. 30, 2020 (JP) 2020-061217

(51) Int. Cl. B60R 21/205; B60R 21/2338

(52) U.S. Cl. CPC B60R 21/205; B60R 2021/23382; B60R 21/2338

(57) ABSTRACT

The front passenger seat airbag includes a main body inflation portion having a front end side attached to the storage portion when inflation is completed, and a protruding inflation portion having a portion protruding rearward from at least one end portion side in a right-left direction on a rear surface side of the main body inflation portion when inflation is completed, the protruding inflation portion protecting a head of the occupant moving obliquely forward during an oblique collision or an offset collision of a vehicle. A pinching portion is formed in a position continuous with a rear end side of the protruding inflation portion, and regulates an outer shape of the protruding inflation portion when inflation is completed, and the pinching portion is formed by joining to-be-joined portions separated from each other in a state in which a bag panel constituting the outer peripheral wall is flatly unfolded.

### CROSS-REFERENCE TO RELATED APPLICATIONS

The present application claims the benefit of priority of Japanese Patent Application No. 2020-061217, filed on Mar. 30, 2020, the content of which is incorporated herein by reference.

### TECHNICAL FIELD

The present disclosure relates to a front passenger seat airbag that is folded and stored in a storage portion provided in an instrument panel disposed in front of an occupant seated in a front passenger seat, and inflates to protrude toward a vehicle rear side by flowing inflation gas therein so as to protect the occupant.

### BACKGROUND

A front passenger seat airbag in the related art includes a main body inflation portion having a front end side attached to a storage portion when inflation is completed, and a protruding inflation portion having a portion protruding rearward from a left end side on a rear surface side of the main body inflation portion when inflation is completed.

### SUMMARY

In the front passenger seat airbag in the related art, an outer shape and an orientation of the protruding inflation portion when inflation is completed are regulated by a separate tether disposed inside the airbag. Accordingly, a configuration of the airbag is not simple and there is room for improvement in terms of a simple configuration.

The present disclosure has been made to solve the above problem and an object thereof is to provide a front passenger seat airbag that can stably regulate an outer shape and an orientation of a protruding inflation portion when inflation is completed even with a simple configuration.

The present disclosure provide a front passenger seat airbag that is folded and stored in a storage portion provided in an instrument panel disposed in front of an occupant seated in a front passenger seat, and inflates to protrude toward a vehicle rear side by flowing inflation gas therein so as to protect the occupant,

the front passenger seat airbag having a bag shape obtained by joining peripheral edges of base members that have predetermined shapes and are formed of sheet bodies having flexibility,

the front passenger seat airbag comprising: a main body inflation portion having a front end side attached to the storage portion when inflation is completed; and

a protruding inflation portion having a portion protruding rearward from at least one end portion side in a right-left direction on a rear surface side of the main body inflation portion when inflation is completed, the protruding inflation portion protecting a head of the occupant moving obliquely forward during an oblique collision or an offset collision of a vehicle,

wherein, in an outer peripheral wall, a pinching portion is formed in a position continuous with a rear end side of the protruding inflation portion, and regulates an outer shape of the protruding inflation portion when inflation is completed, and

wherein the pinching portion is formed by joining to-be-joined portions separated from each other in a state in which a bag panel constituting the outer peripheral wall is flatly unfolded.

In the airbag according to the present disclosure, the pinching portion that regulates the outer shape of the protruding inflation portion when inflation is completed is formed by joining the to-be-joint portions separated from each other in a state in which the bag panel constituting the outer peripheral wall is flatly unfolded. In the pinching portion, the peripheral length of the bag panel coupled to the rear end side of the protruding inflation portion can be shortened from a state before the pinching portion is formed. A pinching amount of the pinching portion (amount of change in the dimension of the peripheral length) can be appropriately set by changing a separation distance between the to-be-joined portions and the length dimension of the to-be-joined portions. By changing the pinching amount (changing a shape of the pinching portion), the outer shape and the orientation of the protruding inflation portion protruding rearward from the rear surface of the main body inflation portion can be appropriately set. Therefore, in the airbag according to the present disclosure, the pinching portion formed by pinching the bag panel does not require a separate member such as a tether, and the protruding inflation portion can be regulated to a predetermined shape.

Accordingly, in the airbag according to the present disclosure, even with a simple configuration, it is possible to stably regulate the outer shape and the orientation of the protruding inflation portion when inflation is completed.

In the front passenger seat airbag of the present disclosure, the protruding inflation portion may include an inner wall portion disposed on the rear surface side of the main body inflation portion and an outer wall portion facing the inner wall portion in the left-right direction, and

the pinching portion may be formed at at least one portion of an outer wall panel constituting the outer wall portion or an inner wall panel constituting the inner wall portion.

According to the front passenger seat airbag having such a configuration, the orientation or the like of the protruding inflation portion in an inner-outer direction can be easily changed by providing the pinching portion at at least one portion of the outer wall portion or the inner wall portion.

Specifically, in the front passenger seat airbag having the above configuration, when the pinching portion is configured such that a joint portion, which is formed by joining the to-be-joint portions separated from each other in a front-rear direction in a state in which the outer wall panel is flatly unfolded, is disposed substantially in an upper-lower direction and is located in a position rearward of a rear surface of the main body inflation portion when inflation is completed, the peripheral length of the outer wall portion in the front-rear direction can be shortened as compared with a case in which no pinching grip portion is provided, and the top end of the protruding inflation portion can be disposed to face an outer side away from the main body inflation portion as compared with the case in which no pinching portion is provided when inflation of the airbag is completed. Such an effect can be similarly obtained when the outer wall panel is integrated with a side wall panel constituting a side wall portion of the main body inflation portion, and when the pinching portion is formed in a position in front of the rear surface of the main body inflation portion when inflation is completed.

On the other hand, in the front passenger seat airbag having the above configuration, when the pinching portion is configured such that a joint portion, which is formed by joining the to-be-joint portions separated from each other in a front-rear direction in a state in which the inner wall panel is flatly unfolded, is disposed substantially in an upper-lower direction, the peripheral length of the inner wall portion in the front-rear direction can be shortened as compared with a case in which no pinching grip portion is provided, and the top end of the protruding inflation portion can be disposed to face an inner side that is the main body inflation portion as compared with the case in which no pinching portion is provided when inflation of the airbag is completed.

In the front passenger seat airbag having the above configuration, the pinching portion may be configured such that a joint portion, which is formed by joining the to-be-joint portions separated from each other in an upper-lower direction in a state in which the outer wall panel or the inner wall panel is flatly unfolded, is disposed substantially in a front-rear direction. In a case of such a configuration, a wide planar portion may be provided on the inner wall portion or the outer wall portion by providing the pinching portion. For example, when the pinching portion is provided on the inner wall portion, the inner wall portion that supports and stops the head of the occupant can be widely disposed in a planar shape so that the head of the occupant can be stably supported and stopped. On the other hand, in a case where the pinching portion is provided on the outer wall portion, for example, when a monitor or the like of a car navigation system that has a portion protruding from the instrument panel is disposed close to the left wall portion, interference with such a monitor can be stably prevented.

In the front passenger seat airbag having the above configuration, when the pinching portion protrudes on the inner peripheral surface side of the outer peripheral wall, the pinching portion does not protrude on an outer peripheral surface side of the outer peripheral wall when the airbag is unfolded and inflated, and thus it is possible to prevent the pinching portion from interfering with a member or the like on a vehicle body side, which is preferable.

### BRIEF DESCRIPTION OF DRAWINGS

FIG. 1 is a schematic perspective view of a front passenger seat airbag when viewed from a front left side according to an embodiment of the present disclosure in a state in which the airbag is inflated alone;

FIG. 2 is a left side view of the airbag of FIG. 1;

FIG. 3 is a schematic vertical sectional view of the airbag of FIG. 1 taken in a front-rear direction;

FIG. 4 is a schematic transverse sectional view of the airbag of FIG. 1 taken in the front-rear direction;

FIG. 5 is a plan view illustrating base fabrics constituting the airbag of FIG. 1;

FIG. 6 is a plan view illustrating the rest of the base fabrics constituting the airbag of FIG. 1;

FIGS. 7A to 7C are schematic views when a pinching portion is formed in the airbag of FIG. 1;

FIG. 8 is a schematic transverse sectional view when inflation of the airbag is completed in a front passenger seat airbag device using the airbag of FIG. 1:

FIG. 9 is a schematic transverse sectional view of an airbag taken in a front-rear direction according to another embodiment of the present disclosure in a state in which the airbag is inflated alone;

FIG. 10 is a right side view of an airbag according to still another embodiment of the present disclosure in a state in which the airbag is inflated alone;

FIG. 11 is a schematic transverse sectional view of the airbag of FIG. 10 taken in a front-rear direction;

FIG. 12 is a plan view illustrating a rear left panel portion in a base fabric constituting the airbag of FIG. 10;

FIG. 13 is a schematic transverse sectional view when inflation of the airbag is completed in a front passenger seat airbag device using the airbag of FIG. 10:

FIG. 14 is a right side view of an airbag according to still another embodiment of the present disclosure in a state in which the airbag is inflated alone; and

FIG. 15 is a plan view illustrating a rear left panel portion in a base fabric constituting the airbag of FIG. 14.

### DESCRIPTION OF EMBODIMENTS

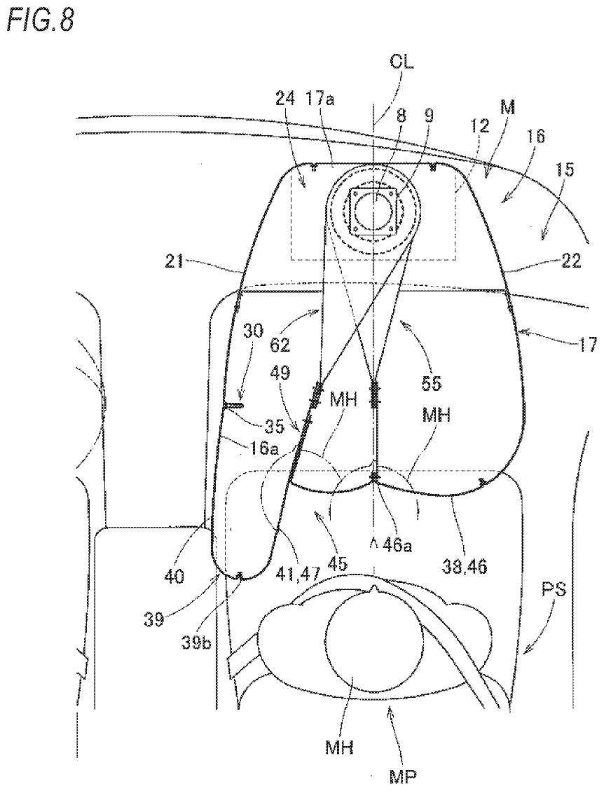

Hereinafter, an embodiment of the present disclosure will be described with reference to the drawings. As illustrated in FIG. 8, a front passenger seat airbag (hereinafter, simply referred to as “airbag”) 15 according to the embodiment is used in a front passenger seat airbag device M disposed inside an instrument panel 1 in front of a front passenger seat PS of a vehicle that is a left-hand drive vehicle. The front passenger seat PS is disposed on a right side of the vehicle. In the embodiment, front-rear, upper-lower, and left-right directions coincide with front-rear, upper-lower, and left-right directions of the vehicle, unless otherwise specified.

As illustrated in FIG. 8, the airbag device M includes the airbag 15, an inflator 8 that supplies inflation gas to the airbag 15, a case 12 serving as a storage portion that stores and holds the airbag 15 and the inflator 8, and a retainer 9 that attaches the airbag 15 and the inflator 8 to the case 12. Although detailed illustration is omitted, the airbag device M further includes an airbag cover that covers an upper side of the folded airbag 15. The airbag cover includes a door portion that is opened when the airbag 15 unfolds and inflates. In the embodiment, the inflator 8 operates at the time of a front collision, an oblique collision, and an offset collision of the vehicle.

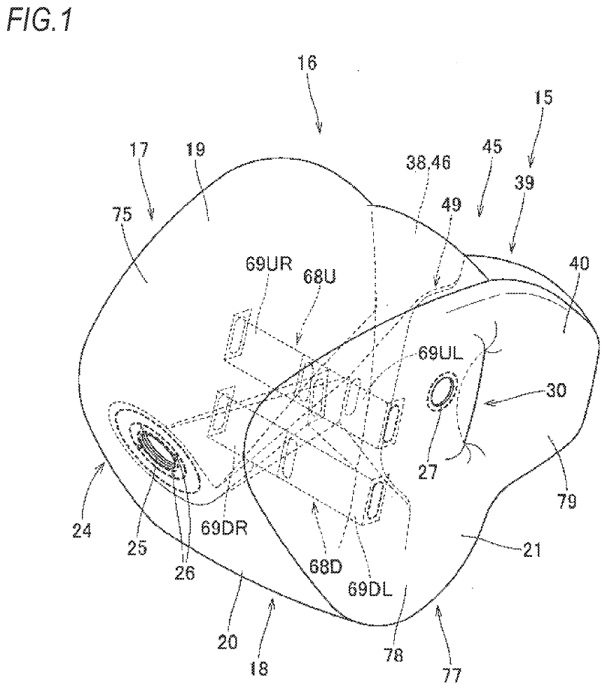

As illustrated in FIGS. 1 to 4, the airbag 15 includes a bag main body 16 that inflates by flowing inflation gas therein and constitutes an outer peripheral wall, and tethers 55, 62, 68U, and 68D that are disposed inside the bag main body 16 and regulate a shape of the bag main body 16 when inflation is completed.

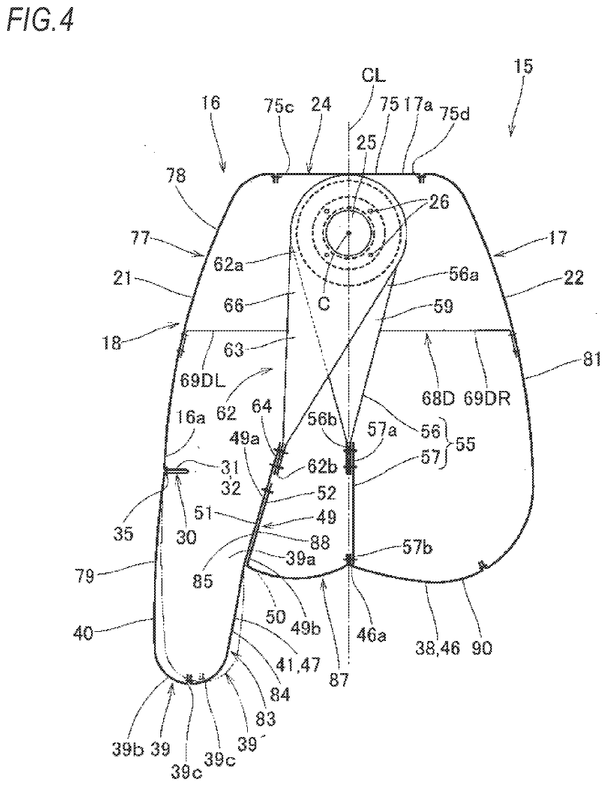

As illustrated in FIGS. 1 and 4, the bag main body 16 has a bag shape formed of a flexible sheet body and includes a main body inflation portion 17 and a protruding inflation portion 39 having one portion protruding rearward from a left end side on a rear surface side of the main body inflation portion 17.

The main body inflation portion 17 is disposed between the instrument panel 1 and a windshield (not illustrated) when inflation is completed, and has a substantially triangular columnar shape when inflation is completed having the axial direction substantially in the left-right direction, as is illustrated in FIG. 1. The main body inflation portion 17 includes an attachment portion 24 attached to the case 12 on a front end 17a when inflation is completed. The main body inflation portion 17 includes a rear wall portion 38 disposed on the rear surface side that is an occupant MP side when inflation is completed, and a tapered peripheral wall portion 18 that extends forward from a peripheral edge of the rear wall portion 38 and converges to reduce its width dimension in the upper-lower direction toward a front end side of the main body inflation portion 17. In the embodiment, the width dimension of the peripheral wall portion 18 in the left-right direction is also slightly reduced toward a front end side.

The peripheral wall portion 18 is mainly disposed between the instrument panel 1 and the windshield (not illustrated) when inflation of the airbag 15 is completed, and includes an upper wall portion 19 and a lower wall portion 20 that face each other in the upper-lower direction, and a left wall portion 21 and a right wall portion 22 that face each other in the left-right direction. In the airbag 15 according to the embodiment, a portion of the peripheral wall portion 18 on the front end side when inflation is completed serves as the attachment portion 24 that attaches the airbag 15 to the case 12. As illustrated in FIG. 4, the attachment portion 24 has, on a lower surface side (lower wall portion 20 side) thereof when inflation is completed, a gas inflow port 25 opened in a substantially circular shape to flow inflation gas therein, and a plurality of (four in the embodiment) attachment holes 26 through which bolts (not illustrated) of the retainer 9 are inserted at a peripheral edge of the gas inflow port 25. By attaching the peripheral edge of the gas inflow port 25 to the case 12 using the retainer 9, the airbag 15 is attached to the case 12 at a portion of the attachment portion 24 (front end 17a side of the main body inflation portion 17) (see FIG. 8). In addition, each of the left wall portion 21 and the right wall portion 22 of the peripheral wall portion 18 has a vent hole 27 that discharges excess inflation gas that has flown into the main body inflation portion 17.

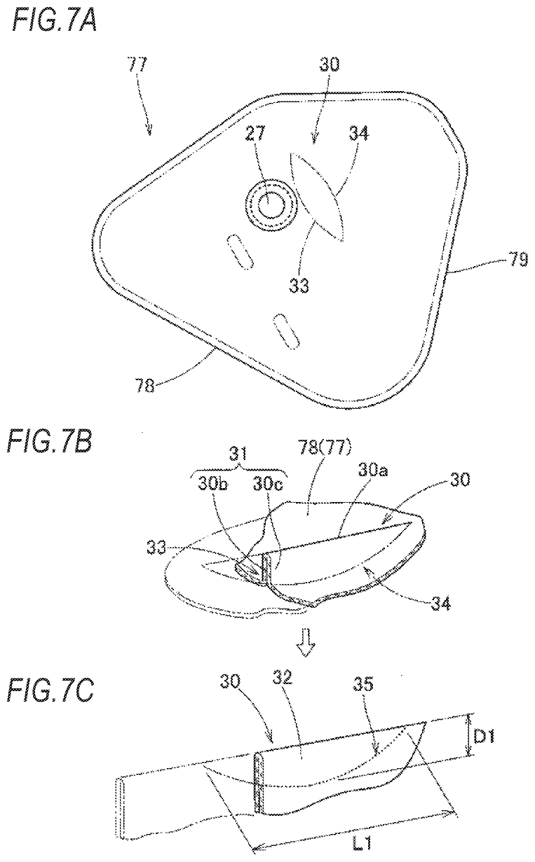

The main body inflation portion 17 according to the embodiment further includes, in the vicinity of a rear edge 21a of the left wall portion 21 in a position where the left wall portion 21 is continuous with a rear end 39b side of the protruding inflation portion 39, a pinching portion 30 that regulates an outer shape of the protruding inflation portion 39 of the airbag 15 (bag main body 16) when inflation is completed. In the case of the embodiment, the pinching portion 30 is provided in a region of a left panel portion 77 to be described later, which serves as a bag panel constituting the bag main body 16 (outer peripheral wall thereof), on a main body portion 78 side in the vicinity of a boundary portion between a main body portion 78, which constitutes the left wall portion 21, and a protruding portion constituting portion 79, which constitutes a left wall portion 40 serving as an outer wall portion to be described later of the protruding inflation portion 39. Specifically, as illustrated in FIGS. 7A to 7C, the pinching portion 30 is obtained by forming a fold substantially in the upper-lower direction at a portion on a rear edge 78c side of the main body portion 78 from a state in which the left panel portion 77 is flatly unfolded, overlapping to-be-joined portions 33, 34 having curving shapes and separated from each other in the front-rear direction, that is, overlapping panel members 30b, 30c extending from a fold 30a to face each other, forming an overlapping portion 31, and then sewing the to-be-joined portions 33, 34 to form a joined portion 35. In the case of the embodiment, the overlapping portion 31 is disposed on an inner peripheral surface 16a side of the bag main body 16 (outer peripheral wall) (see FIG. 4). The to-be-joint portions 33, 34, which constitute the pinching portion 30 (joint portion 35) at the time of joining, curve in a substantial arc shape to be most distant from each other on a central side and approach each other on two end sides, and define a shape similar to a flat rugby ball (see FIG. 7A).

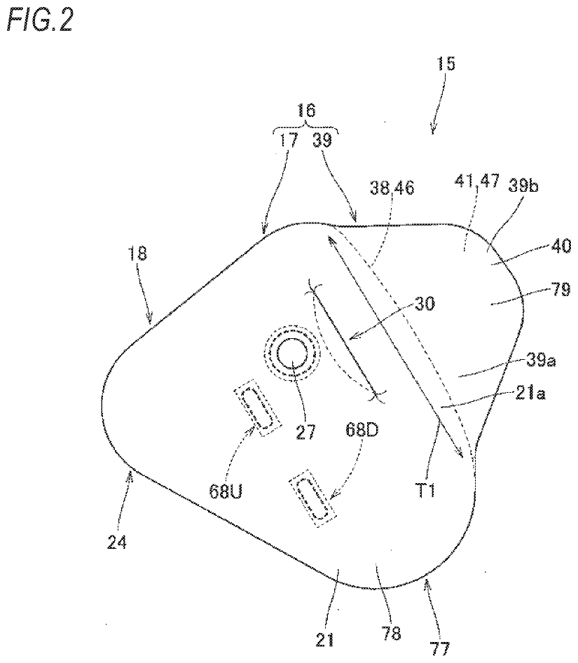

In detail, as illustrated in FIG. 2, the pinching portion 30 (joint portion 35) is disposed substantially in the upper-lower direction in a region in front of the protruding inflation portion 39 (region above a central portion of the left wall portion 21 in the upper-lower direction) on a rear edge 21a side of the left wall portion 21 to substantially follow the rear wall portion 38. Specifically, the pinching portion 30 is disposed in front of an upper half region of the protruding inflation portion 39 with a length dimension L1 (see FIG. 7C) in the upper-lower direction being about ½ of a width dimension T1 (see FIG. 2) of the protruding inflation portion 39 in the vicinity of the front end 39a in the upper-lower direction, and a pinching amount (separation distance D1 between the fold 30a and the to-be-joined portions 33, 34, see FIG. 7C) is set to such an amount that a top end (rear end 39b) of the protruding inflation portion 39 is disposed toward a left side of the airbag 15 when inflation is completed.

The rear wall portion 38 is disposed substantially in the upper-lower direction on the rear surface side that is the occupant MP side when inflation of the airbag 15 is completed. The protruding inflation portion 39 is disposed at a portion on a left end side that is a driver seat side, and inflates such that a portion thereof protrudes rearward.

When inflation of the airbag 15 is completed, the protruding inflation portion 39 is disposed in a position leftward and obliquely forward of an occupant MP seated in the front passenger seat PS (see FIG. 8). The protruding inflation portion 39 communicates with the main body inflation portion 17 on a front end 39a side w % ben inflation is completed, and flows inflation gas therein through the main body inflation portion 17 (see FIGS. 4 and 8). As illustrated in FIG. 2, an outer shape of the protruding inflation portion 39 when viewed from the left-right direction when inflation is completed is a substantially trapezoidal shape in which the front end 39a side, which is a main body inflation portion 17 side, has a large width and the width is reduced toward the rear end 39b side. The protruding inflation portion 39 includes the left wall portion 40 (outer wall portion) and a right wall portion 41 (inner wall portion) that face each other in the left-right direction when inflation is completed. In the case of the embodiment, the protruding inflation portion 39 has a substantial plate shape in which outer peripheral edges of the left wall portion 40 and the right wall portion 41 are joined to each other. Dimensions of the outer shape of the protruding inflation portion 39 (width dimension in the upper-lower direction and width dimension in the front-rear direction (protruding amount from the rear wall portion 38)) are set to such dimensions that a head MH of the occupant MP moving obliquely forward can be stably supported and stopped by the right wall portion 41 (oblique collision restraint surface 47 to be described later) when inflation of the airbag 15 is completed. In the embodiment, the outer shape of the protruding inflation portion 39 when inflation is completed is regulated by the pinching portion 30. In detail, in a cross section substantially in a horizontal direction (front-rear direction) when inflation is completed, a top portion 39c on the rear end 39b (top end) side is shifted leftward than the top portion 39c (see a two-dot chain line in FIG. 8) of a protruding inflation portion 39′ in a case where no pinching portion is provided. That is, when inflation of the airbag 15 is completed, the top end (rear end 39b) of the protruding inflation portion 39 faces an outer side (left side) away from the main body inflation portion 17.

The airbag 15 according to the embodiment is configured such that a region on a rear side when inflation is completed serves as an occupant protection portion 45 that can protect the occupant MP. Specifically, in the airbag 15, the protruding inflation portion 39 and the rear wall portion 38 of the main body inflation portion 17 constitute the occupant protection portion 45. The occupant protection portion 45 includes a front collision restraint surface 46 that can protect the head MH of the occupant MP moving forward at the time of a front collision of the vehicle, the oblique collision restraint surface 47 that can protect the head MH of the occupant MP moving obliquely forward at the time of an oblique collision, an offset collision, or the like of the vehicle, and a restraint concave portion 49 that is disposed between the front collision restraint surface 46 and the oblique collision restraint surface 47 and allows the head MH of the occupant MP to enter and restrains the head MH.

In the case of the embodiment, the front collision restraint surface 46 is provided in a region of the rear wall portion 38 on right of the protruding inflation portion 39 in the airbag 15 when inflation is completed. The front collision restraint surface 46 is configured such that a region thereof in the vicinity of an intersection with a center line CL passing through an attachment center C substantially in the front-rear direction is set as a supporting and stopping center 46a that supports and stops the head MH of the occupant MP moving forward, and that the vicinity of the supporting and stopping center 46a is slightly recessed forward in a transverse section substantially in the front-rear direction when inflation of the airbag 15 is completed (see FIG. 4).

The oblique collision restraint surface 47 is constituted by the right wall portion 41 of the protruding inflation portion 39 in which the right wall portion 41 serves as the inner wall portion continuous with the front collision restraint surface 46 when inflation is completed. When inflation of the airbag 15 is completed, the oblique collision restraint surface 47 is slightly inclined relative to the front-rear direction so that a rear edge 47a is located to the left side in response to an inclination of the protruding inflation portion 39.

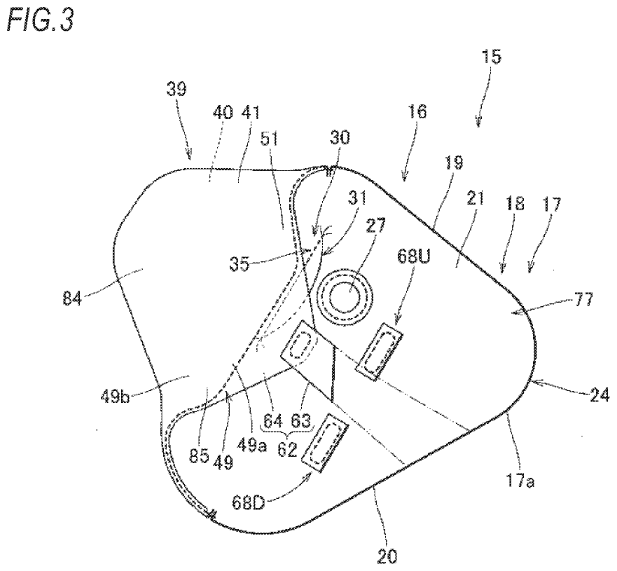

The restraint concave portion 49 formed between the front collision restraint surface 46 and the oblique collision restraint surface 47 allows the head MH of the occupant MP to enter and restrains the head MH. In the case of the embodiment, the restraint concave portion 49 is formed substantially in the upper-lower direction at a boundary portion between a right region of the protruding inflation portion 39 and the rear wall portion 38 of the main body inflation portion 17, and is recessed forward in a pocket shape with a rear end 49b side opened, as is illustrated in FIGS. 3 and 4. The restraint concave portion 49 includes a left side wall 51 and a right side wall 52 that have substantially rectangular shapes wide in the upper-lower direction when viewed from the left-right direction, and has a substantially pocket shape with the rear end 49b side opened by joining (sewing) upper edges, lower edges, and front edges of the left side wall 51 and the right side wall 52 to each other. The length dimension (opening width dimension of an opening 50) of the restraint concave portion 49 in the upper-lower direction is set to such a dimension that the head MH of the occupant MP can smoothly enter the restraint concave portion 49, and the width dimension (depth) of the restraint concave portion 49 in the front-rear direction is set to such a dimension that a region on a front side of the head MH of the occupant MP can enter the restraint concave portion 49. In the case of the embodiment, as illustrated in FIGS. 3 and 4, a top end (front end 49a) side of the restraint concave portion 49 is coupled to the concave portion tether 62 disposed in the bag main body 16, and a top end (front end 49a) of the concave portion is pulled forward when inflation of the airbag 15 is completed. In the case of the embodiment, the restraint concave portion 49 extends substantially in the front-rear direction continuously from the right wall portion 41 (oblique collision restraint surface 47) of the protruding inflation portion 39 in a state in which the opening 50 on the rear end 49b side is prevented from opening so that the left side wall 51 and the right side wall 52 are brought into contact with each other over substantially the entire region when inflation of the airbag 15 is completed.

As illustrated in FIGS. 1 to 4, the front-rear tether 55, the concave portion tether 62, and the left and right tethers 68U and 68D, which are disposed in a region of the main body inflation portion 17, are disposed in the bag main body 16.

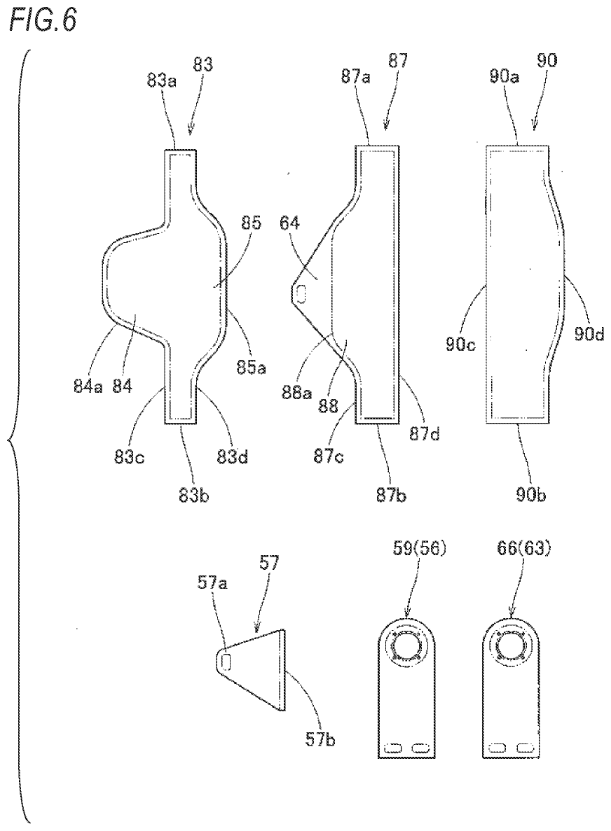

As illustrated in FIG. 4, the front-rear tether 55 couples a portion of the front collision restraint surface 46 that intersects with the center line CL (in the vicinity of the supporting and stopping center 46a) with the front end 17a side of the airbag 15 (main body inflation portion 17). When inflation of the airbag 15 is completed, the front-rear tether 55 is located on the center line CL and couples a front portion 56 extending from a peripheral edge of the gas inflow port 25 with a rear portion 57 extending from the rear wall portion 38 side. In the case of the embodiment, the front portion 56 is formed by folding a belt-shaped front portion member 59 illustrated in FIG. 6, and an outer shape of the front portion 56 when inflation of the bag main body 16 is completed is a substantially three-dimensional triangular pyramid shape in which a front end 56a side is substantially in the left-right direction and a rear end 56b side is substantially in the upper-lower direction. The rear portion 57 has a substantially trapezoidal outer shape having a small width toward a front end 57a coupled to the front portion 56. In the case of the embodiment, a rear edge of the rear portion 57 is sewn to a right edge 87d of a rear central panel portion 87 and a left edge 90c of a rear right panel portion 90, which will be described later, and is coupled to the front collision restraint surface 46 (rear wall portion 38) in a substantially central position in the upper-lower direction. The front-rear tether 55 is disposed to prevent the airbag 15 from protruding excessively rearward when the airbag 15 is unfolded and inflated, and to regulate a separation distance of the rear wall portion 38 from a front end of the bag main body 16 (front end 17a of the main body inflation portion 17) when inflation of the airbag 15 is completed. In the case of the embodiment, by disposing the front-rear tether 55 inside the airbag 15, the supporting and stopping center 46a of the rear wall portion 38 (front collision restraint surface 46) is slightly recessed forward in the upper-lower direction when inflation of the airbag 15 is completed.

As illustrated in FIG. 4, the concave portion tether 62 couples the top end (front end 49a) side of the restraint concave portion 49 with the front end side of the airbag 15 (front end 17a side of the main body inflation portion 17) when inflation of the airbag 15 is completed. The concave portion tether 62 couples a front portion 63 extending from the peripheral edge of the gas inflow port 25 with a rear portion 64 extending from a restraint concave portion 49 side. In the case of the embodiment, as illustrated in FIG. 6, the front portion 63 is formed in the same manner as the front portion 56 by folding a belt-shaped front portion member 66 having substantially the same outer shape as the front portion member 59 forming the front portion 56 of the front-rear tether 55. In the case of the embodiment, the rear portion 64 is integrated with a concave portion part 88 of the rear central panel portion 87 constituting the restraint concave portion 49, extends from the concave portion part 88, and has a substantially trapezoidal shape having a small width toward a front end side (see FIG. 6). The concave portion tether 62 is inclined relative to the front-rear direction so that a front end 62a side is on a right side and a rear end 62b side is on a left side when inflation of the airbag 15 is completed, and that the restraint concave portion 49 is continuous with the concave portion tether 62 (see FIG. 4).

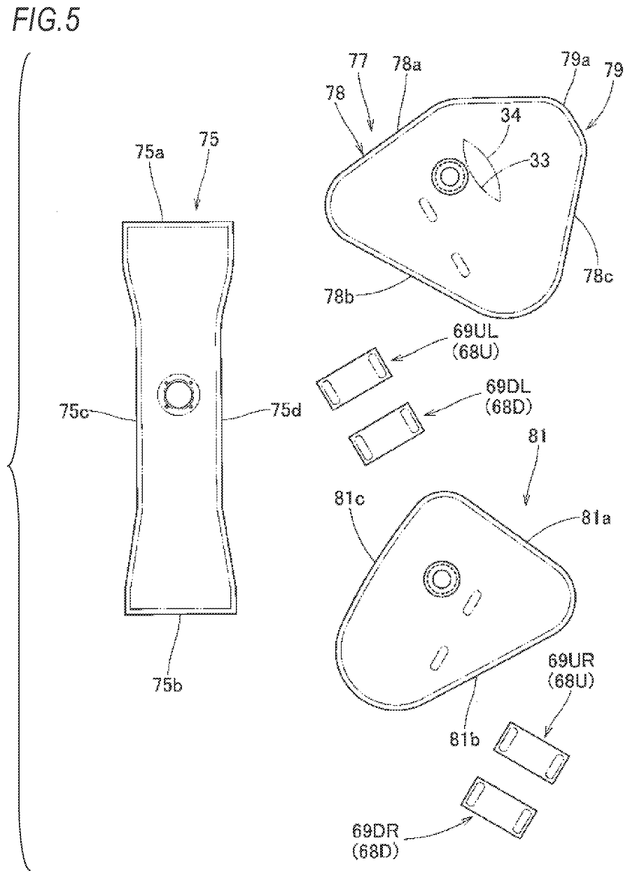

The left and right tethers 68U, 68D are disposed substantially in the left-right direction inside the bag main body 16 to couple the left wall portion 21 and the right wall portion 22 of the peripheral wall portion 18 that face each other in the left-right direction. In the case of the embodiment, each of the left and right tethers 68U, 68D has a belt shape in which a width direction is substantially in the upper-lower direction at two portions on an upper side and a lower side of each of the front-rear tether 55 and the concave portion tether 62. In the embodiment, the right and left tethers 68U, 68D respectively include a pair of tether base members 69UL, 69UR and a pair of tether base members 69DL, 69DR as illustrated in FIG. 5. The left and right tethers 68U, 68D are configured to prevent the left wall portion 21 and the right wall portion 22 from being excessively separated from each other when the airbag 15 is unfolded and inflated, and to regulate a separation distance between the left wall portion 21 and the right wall portion 22 when inflation of the airbag 15 is completed.

The bag main body 16 (outer peripheral wall of the airbag 15) is formed in a bag shape by joining peripheral edges of a base cloth (bag panel) having a predetermined shape with each other. In the case of the embodiment, as illustrated in FIGS. 5 and 6, the bag main body 16 includes the left panel portion 77, a right panel portion 81, a front panel portion 75, a rear left panel portion 83, the rear central panel portion 87, and the rear right panel portion 90.

The front panel portion 75 is formed in a substantial belt shape elongated in the front-rear direction in which a portion in the vicinity of a center constituting a front region of the peripheral wall portion 18 has a small width and the width slightly increases toward two front and rear end sides. The front panel portion 75 extends from the upper wall portion 19 to the lower wall portion 20, which face each other in the upper-lower direction, in the main body inflation portion 17 when inflation is completed. The front panel portion 75 has a bilaterally symmetrical shape.

The left panel portion 77 serves as a bag extends from the left wall portion 21 of the main body inflation portion 17 when inflation is completed to the left wall portion 40 of the protruding inflation portion 39. Specifically, the left panel portion 77 couples the substantially trapezoidal protruding portion constituting portion 79 (outer wall panel), which constitutes the left wall portion 40 of the protruding inflation portion 39, to a rear end side of the substantially triangular main body portion 78 (side wall panel), which constitutes the left wall portion 21 of the main body inflation portion 17. As described above, the pinching portion 30 is formed on the rear edge side of the main body portion 78 in the left panel portion 77 (in the vicinity of the boundary portion between the main body portion 78 and the protruding portion constituting portion 79) by joining the to-be-joint portions 33, 34 (see FIGS. 5 and 7). The right panel portion 81 constitutes the right wall portion 22 of the main body inflation portion 17, and has a substantially triangular outer shape that is substantially the same as the outer shape of the main body portion 78 in the left panel portion 77.

The rear left panel portion 83 is formed in a substantial belt shape that constitutes a portion on a left edge side of the rear wall portion 38 in the main body inflation portion 17 when inflation is completed, and includes two protruding portions of a protruding portion constituting portion 84 constituting the right wall portion 41 of the protruding inflation portion 39 and a concave portion part 85 constituting the left side wall 51 of the restraint concave portion 49. Specifically, the protruding portion constituting portion 84 protrudes from a left edge 83c of the rear left panel portion 83 in a flatly unfolded state, and the concave portion part 85 protrudes from a right edge 83d.

The rear central panel portion 87 constitutes a region on a left side of the supporting and stopping center 46a of the rear wall portion 38 (front collision restraint surface 46), and is formed in a substantial belt shape whose longitudinal direction is substantially in the upper-lower direction. The concave portion part 88 constituting the right side wall 52 of the restraint concave portion 49 has a portion protruding from a left edge 87c of the rear central panel portion 87. The rear portion 64 of the concave portion tether 62 is integrated with the concave portion part 88 to extend from a top end of the concave portion part 88. The rear right panel portion 90 constitutes a region on a right side of the supporting and stopping center 46a of the rear wall portion 38 (front collision restraint surface 46), and is formed in a substantial belt shape whose longitudinal direction is substantially in the upper-lower direction.

In the embodiment, the left panel portion 77, the right panel portion 81, the front panel portion 75, the rear left panel portion 83, the rear central panel portion 87, and the rear right panel portion 90 that constitute the bag main body 16, the rear portion 57, the front portion member 59 that constitutes the front portion 56 of the front-rear tether 55, the front portion member 66 that constitutes the front portion 63 of the concave portion tether 62, and the tether base members 69UL, 69UR, 69DL, and 69DR that constitute the left and right tethers 68U, 68D are all formed of flexible woven fabrics having and made of polyester yarn, polyamide yarn, or the like.

As illustrated in FIGS. 5 and 6, the bag main body 16 according to the embodiment is formed into a bag shape by sewing (joining) corresponding edge portions of the left panel portion 77, the right panel portion 81, the front panel portion 75, the rear left panel portion 83, the rear central panel portion 87, and the rear right panel portion 90 using a sewing thread. Specifically, a rear upper edge 75a of the front panel portion 75 is joined to upper edges 83a. 87a, 90a of the rear left panel portion 83, the rear central panel portion 87, and the rear right panel portion 90, and a rear lower edge 75b is joined to lower edges 83b. 87b, 90b of the rear left panel portion 83, the rear central panel portion 87, and the rear right panel portion 90. A left edge 75c of the front panel portion 75 is joined to a portion extending from an upper edge 78a to a lower edge 78b of the main body portion 78 of the left panel portion 77, and a right edge 75d of the front panel portion 75 is joined to a portion extending from an upper edge 81a to a lower edge 81b of the right panel portion 81. The left edge 83c of the rear left panel portion 83 is joined to a rear edge 78c of the main body portion 78 of the left panel portion 77. At this time, outer edges 79a, 84a of the protruding portion constituting portions 79, 84 are also joint with each other. The right edge 83d of the rear left panel portion 83 is joined to the left edge 87c of the rear central panel portion 87. At this time, outer edges 85a, 88a of the concave portion constituting portions 85, 88 are also joint with each other. The right edge 87d of the rear central panel portion 87 is joined to the left edge 90c of the rear right panel portion 90. A right edge 90d of the rear right panel portion 90 is joined to a rear edge 81c of the right panel portion 81.

In the front passenger seat airbag device M according to the embodiment, the airbag 15 with the retainer 9 stored therein is stored in the case 12 in a state in which the airbag 15 is folded to be stored in the case 12 and the periphery thereof is wrapped in a breakable wrapping sheet (not illustrated), and the inflator 8 is coupled to the case 12 together with the peripheral edge of the gas inflow port 25 of the airbag 15 using the retainer 9. Thereafter, when the case 12 holding the folded airbag 15 and the inflator 8 is coupled to the airbag cover (not illustrated) formed on the instrument panel 1 mounted on the vehicle, the airbag device M can be mounted on the vehicle.

In the front passenger seat airbag device M according to the embodiment, the inflator 8 operates at the time of the front collision, the oblique collision, or the offset collision of the vehicle in a state where the airbag device M is mounted on the vehicle, and the airbag 15 inflates by flowing inflation gas therein, protrudes from the case 12, and completes inflation as illustrated in FIG. 8.

In the airbag 15 according to the embodiment, the pinching portion 30 that regulates the outer shape of the protruding inflation portion 39 when inflation is completed is formed by joining the to-be-joint portions 33, 34 separated from each other in a state in which the left panel portion 77, which serves as a bag panel constituting the outer peripheral wall, is flatly unfolded. In the pinching portion 30, the peripheral length (peripheral length of the left panel portion 77 in a cross section in the front-rear direction in the embodiment) of the bag panel (left panel portion 77 in the embodiment) coupled to the rear end 39b side of the protruding inflation portion 39 can be shortened from a state before the pinching portion 30 is formed. The pinching amount of the pinching portion 30 (amount of change in the dimension of the peripheral length) can be appropriately set by changing a separation distance between the to-be-joined portions 33, 34 and the length dimension of the to-be-joined portions 33, 34 (pinching portion 30, joined portion 35). By changing the pinching amount (changing a shape of the pinching portion 30), the outer shape and the orientation of the protruding inflation portion 39 protruding rearward from the rear surface of the main body inflation portion 17 can be appropriately set. Therefore, in the airbag 15 according to the embodiment, the pinching portion 30 formed by pinching the bag panel (left panel portion 77 in the case of the embodiment) does not require a separate member such as a tether, and the protruding inflation portion 39 can be regulated to a predetermined shape.

Accordingly, in the airbag 15 according to the embodiment, even with a simple configuration, it is possible to stably regulate the outer shape and the orientation of the protruding inflation portion 39 when inflation is completed.

Specifically, in the airbag 15 according to the embodiment, the pinching portion 30 is formed on the left wall portion 40 serving as the outer wall portion on a side away from the main body inflation portion 17 in the protruding inflation portion 39. More specifically, the pinching portion 30 is configured such that the joint portion 35, which is formed by joining the to-be-joined portions 33, 34 separated in the front-rear direction in a state in which the left panel portion 77 is flatly unfolded, is disposed substantially in the upper-lower direction at a portion of the main body portion 78 in the left panel portion 77 from the left wall portion 21 of the main body inflation portion 17 to the left wall portion 40 of the protruding inflation portion 39. For this reason, in the airbag 15 when inflation is completed, the peripheral length in the front-rear direction from the left wall portion 21 to the left wall portion 40 can be made shorter than that in a case where no pinching portion is provided. When inflation of the airbag 15 is completed, the top end (rear end 39b) of the protruding inflation portion 39 can be disposed to face the outer side away from the main body inflation portion 17 as compared with the protruding inflation portion 39′ in the case where no pinching portion is provided (see FIGS. 4 and 8).

As in the airbag 15 according to the embodiment, when the top end (rear end 39b) of the protruding inflation portion 39 faces the outer side away from the main body inflation portion 17 when inflation is completed, it is possible to stably restrain the head of the occupant moving leftward and obliquely forward at the time of an oblique collision or an offset collision by the protruding inflation portion 39 in a case where a movement angle of the head in the front-rear direction is relatively large.

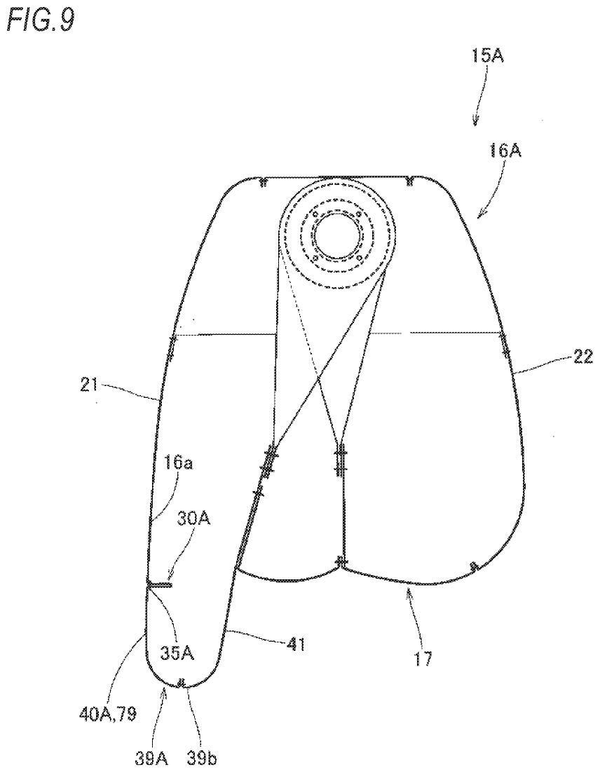

In the embodiment, the protruding portion constituting portion 79 (outer wall panel) constituting the left wall portion 40 (outer wall portion) of the protruding inflation portion 39 is integrated with the main body portion 78 (side wall panel) constituting the left wall portion 21 of the main body inflation portion 17, and the pinching portion 30 is formed in the vicinity of the rear edge 21a of the left wall portion 21 of the main body inflation portion 17 disposed continuously with the front side of the left wall portion 40. However, as in an airbag 15A illustrated in FIG. 9, a pinching portion 30A that reduces the peripheral length in the front-rear direction may be provided in the left wall portion 40 (region of the protruding portion constituting portion 79) of a protruding inflation portion 39A. In such a configuration, a bag panel constituting an airbag may be configured such that an outer wall panel constituting a left wall portion (outer wall portion) of a protruding inflation portion is separate from a side wall panel constituting a left wall portion of a main body inflation portion.

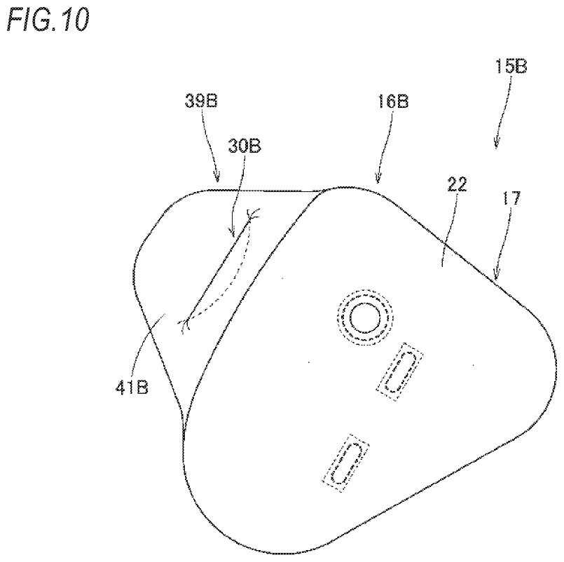

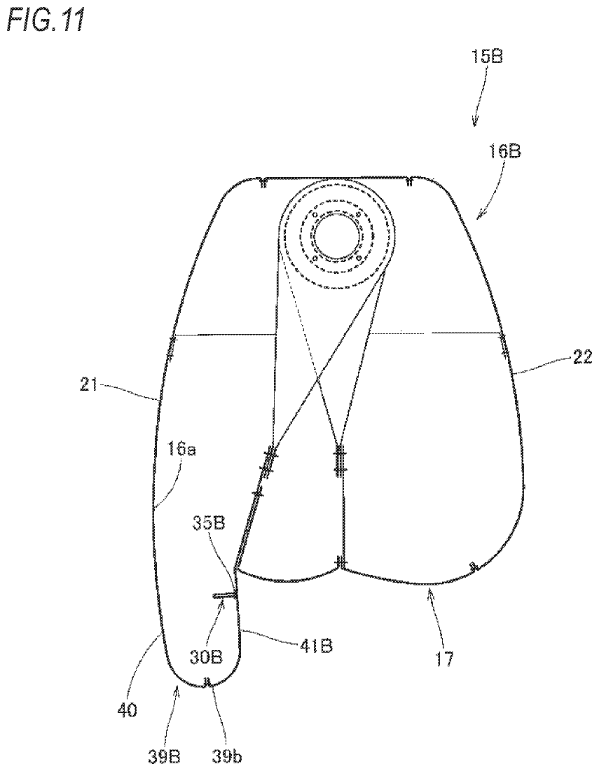

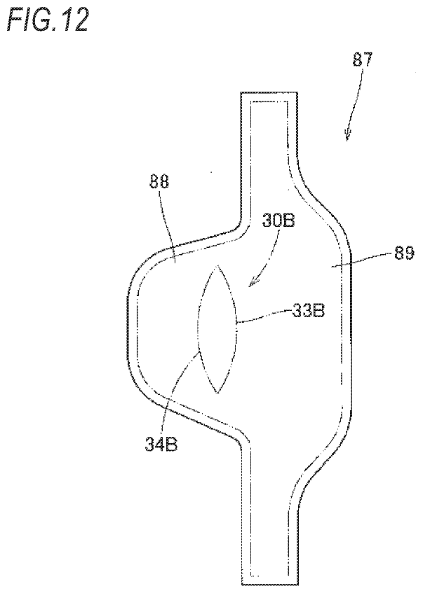

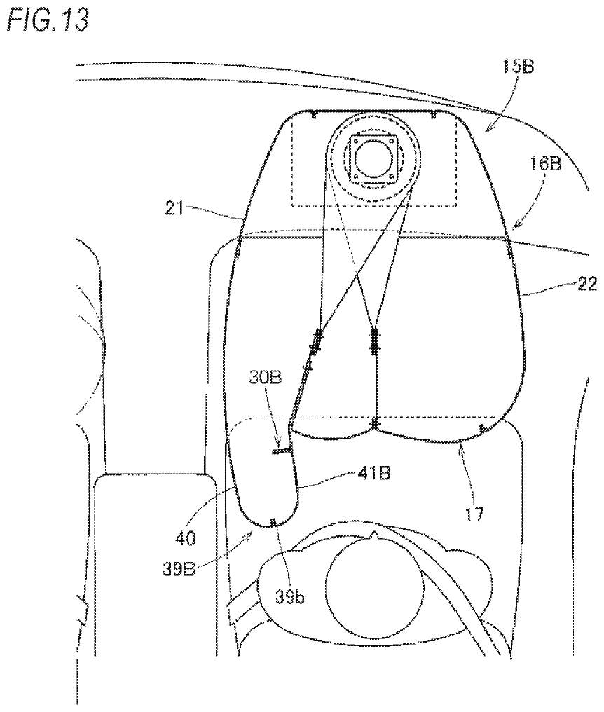

Further, as illustrated in FIGS. 10 and 11, an airbag 15B may be configured such that a pinching portion 30B that reduces the peripheral length in the front-rear direction is formed on a right wall portion 41B serving as the inner wall portion disposed on the rear surface side (rear wall portion 38 side) of the main body inflation portion 17 in a protruding inflation portion 39B. The airbag 15B includes a joint portion 35B in the protruding portion constituting portion 84 of the rear left panel portion 83 constituting the right wall portion 41B of the protruding inflation portion 39B. The joint portion 35B joins to-be-joined portions 33B, 34B having curving shapes and separated from each other in the front-rear direction and (pinching portion 30B) is disposed substantially in the upper-lower direction when inflation is completed (see FIGS. 10 and 12). In the airbag 15B having such a configuration, the peripheral length in the front-rear direction of the right wall portion 41B serving as the inner wall portion in the protruding inflation portion 39B can be made shorter than that in the case where no pinching portion is provided. When inflation of the airbag 15B is completed, a top end (rear end 39b) of the protruding inflation portion 39B can be disposed to face an inner side that is a main body inflation portion 17 side as compared with the case where no pinching portion is provided (see FIGS. 11 and 13). As described above, when the top end (rear end 39b) of the protruding inflation portion 39B faces the inner side that is the main body inflation portion 17 side when inflation is completed, it is possible to stably restrain the head of the occupant moving leftward and obliquely forward at the time of an oblique collision or an offset collision by the protruding inflation portion 39B in a case where a movement angle in the front-rear direction of the head is relatively small.

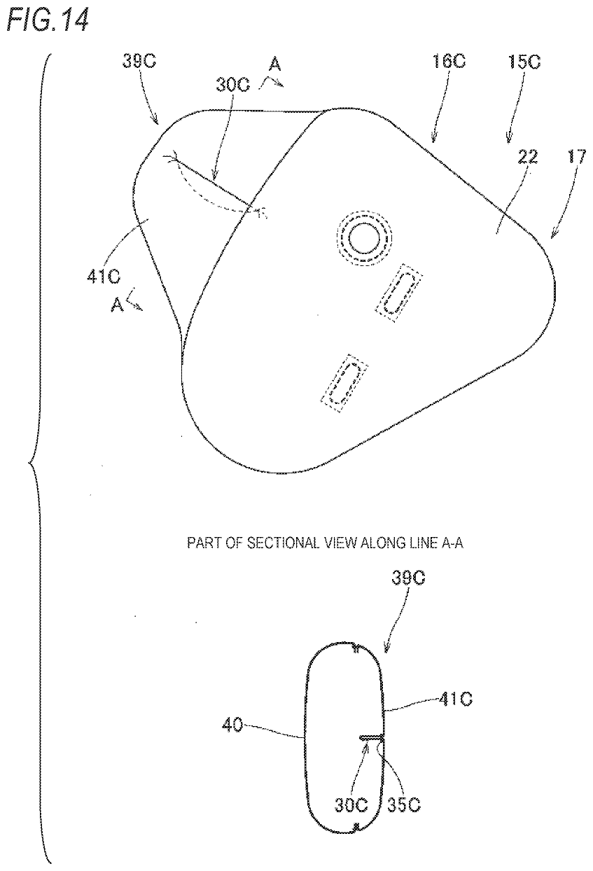

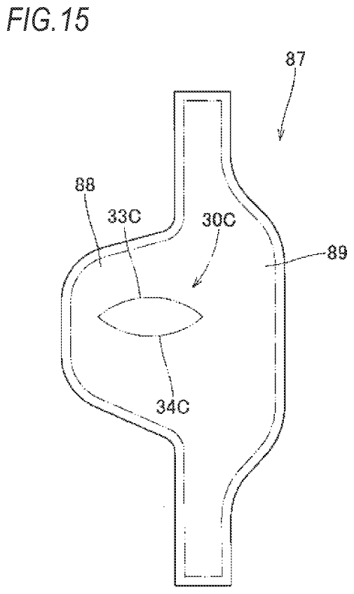

Further, as illustrated in FIG. 14, an airbag 15C may include a pinching portion 30C in which a joint portion 35C extends substantially in the front-rear direction. The airbag 15C includes the joint portion 35C in the protruding portion constituting portion 84 of the rear left panel portion 83 constituting a right wall portion 41C of a protruding inflation portion 39C. The joint portion 35C joins to-be-joined portions 33C, 34C having curving shapes and separated from each other in the upper-lower direction and (pinching portion 30C) is disposed substantially in the upper-lower direction when inflation is completed (see FIGS. 14 and 15). In the airbag 15C having such a configuration, the peripheral length in the front-rear direction of the right wall portion 41C serving as an inner wall portion of the protruding inflation portion 39C can be made shorter than that in the case where no pinching portion is provided, and a wide planar portion can be provided in the right wall portion 41C. For this reason, the right wall portion 41C that supports and stops the head of the occupant can be widely disposed in a planar shape so that the head of the occupant can be stably supported and stopped. Although detailed illustration is omitted, such a pinching portion in the front-rear direction may be disposed on a left wall portion (outer wall portion) side. With the configuration in which the pinching portion is provided on the left wall portion, for example, when a monitor or the like of a car navigation system that has a portion protruding from the instrument panel is disposed close to the left wall portion, interference with such a monitor can be stably prevented.

In the airbags 15, 15A, 15B, and 15C according to the embodiments, the pinching portions 30, 30A, 30B, and 30C protrude on the inner peripheral surface 16a side of the bag main body 16. Therefore, the pinching portions 30, 30A, 30B, and 30C do not protrude on an outer peripheral surface side of the bag main body 16 when the airbags 15, 15A, 15B, and 15C are unfolded and inflated, and it is possible to prevent the pinching portions 30, 30A, 30B, and 30C from interfering with a member or the like on a vehicle body side. Particularly, when the pinching portions 30B, 30C are provided on the right wall portions 41B, 41C that come into contact with the head MH of the occupant MP as in the airbags 15B, 15C, the pinching portions 30B, 30C protrude on the inner peripheral surface 16a side so that there is no portion protruding on a region corresponding to the head MH and the head MH can be smoothly protected. If such a point is not taken into consideration, the pinching portion may protrude on the outer peripheral surface side of the bag main body.

Particularly, in the airbags 15, 15A, 15B, and 15C according to the embodiments, a shape of the protruding inflation portions 39, 39A, 39B, and 39C when inflation is completed is a substantial plate shape by joining outer peripheral edges of the left wall portions 40, 40A and corresponding outer peripheral edges of the right wall portions 41, 41B, and 41C that face each other in the left-right direction. Therefore, the protruding direction and the outer shape of the protruding inflation portions 39, 39A, 39B, and 39C when inflation is completed can be easily controlled with the pinching portions 30, 30A, 30B, and 30C, and a top end side can be easily regulated to face the left side or the right side. If such a point is not taken into consideration, a protruding inflation portion that has a front end side opened and inflates in a substantial box shape may be provided.

In the embodiments, although the to-be-joint portions 33, 34, which constitute the pinching portion 30 (joint portion 35) at the time of joining, curve in a substantial arc shape to be most distant from each other on the central side and approach each other on two end sides, and define a shape similar to a flat rugby ball, the shape of the to-be-joint portions is not limited to the embodiments. For example, the to-be-joint portions may be formed in a shape in which most distant portions (portions having a largest width) are deviated to an end of one of the to-be-joint portions, or in a substantially linear shape in which an end of one to-be-joint portion is brought close to an end of the other to-be-joint portion and the other end of the one to-be-joint portion is separated from the other end of the other to-be-joint portion. However, from a viewpoint of preventing stress concentration on the ends and dispersing the stress generated in the joining portion, it is preferable that the two ends are close to each other and intermediate portions are separated from each other. In addition, although in the airbags 15, 15A, 15B, and 15C according to the embodiments, the pinching portions 30, 30A, 30B, and 30C are formed at only one portion, the pinching portions may be provided at a plurality of portions.

Further, although in the embodiments, the airbag 15 is configured such that the protruding inflation portion 39 is disposed only on a central side (left side) in the vehicle width direction, which is a driver seat side, on the rear surface side of the main body inflation portion 17, the protruding inflation portion may be disposed only on a right side (outer side in the vehicle width direction) on the rear surface side of the main body inflation portion or even disposed on the left and right sides on the rear surface side of the main body inflation portion.

What is claimed is:

1. A front passenger seat airbag that is folded and stored in a storage portion provided in an instrument panel disposed in front of an occupant seated in a front passenger seat, and inflates to protrude toward a vehicle rear side by flowing inflation gas therein so as to protect the occupant,
the front passenger seat airbag having a bag shape obtained by joining peripheral edges of base members that have predetermined shapes and are formed of sheet bodies having flexibility,
the front passenger seat airbag comprising: a main body inflation portion having a front end side attached to the storage portion when inflation is completed; and
a protruding inflation portion having a portion protruding rearward from at least one end portion side in a right-left direction on a rear surface side of the main body inflation portion when inflation is completed, the protruding inflation portion protecting a head of the occupant moving obliquely forward during an oblique collision or an offset collision of a vehicle,
wherein, in an outer peripheral wall, a pinching portion is formed in a position continuous with a rear end side of the protruding inflation portion, and regulates an outer shape of the protruding inflation portion when inflation is completed, and
wherein the pinching portion is formed by joining to-be-joined portions separated from each other in a state in which a bag panel constituting the outer peripheral wall is flatly unfolded.

2. The front passenger seat airbag according to claim 1, wherein the protruding inflation portion includes an inner wall portion disposed on the rear surface side of the main body inflation portion and an outer wall portion facing the inner wall portion in the left-right direction, and
wherein the pinching portion is formed at at least one portion of an outer wall panel constituting the outer wall portion or an inner wall panel constituting the inner wall portion.

3. The front passenger seat airbag according to claim 2, wherein the pinching portion is configured such that a joint portion, which is formed by joining the to-be-joint portions separated from each other in a front-rear direction in a state in which the outer wall panel is flatly unfolded, is disposed substantially in an upper-lower direction and is located in a position rearward of a rear surface of the main body inflation portion when inflation is completed.

4. The front passenger seat airbag according to claim 2, wherein the outer wall panel is integrated with a side wall panel constituting a side wall portion of the main body inflation portion, and
wherein the pinching portion is configured such that a joint portion, which is formed by joining the to-be-joint portions separated from each other in a front-rear direction in a state in which the side wall panel is flatly unfolded, is disposed substantially in an upper-lower direction and is located in a position forward of a rear surface of the main body inflation portion when inflation is completed.

5. The front passenger seat airbag according to claim 2, wherein the pinching portion is configured such that a joint portion, which is formed by joining the to-be-joint portions separated from each other in a front-rear direction in a state in which the inner wall panel is flatly unfolded, is disposed substantially in an upper-lower direction.

6. The front passenger seat airbag according to claim 2, wherein the pinching portion is configured such that a joint portion, which is formed by joining the to-be-joint portions separated from each other in an upper-lower direction in a state in which the outer wall panel or the inner wall panel is flatly unfolded, is disposed substantially in a front-rear direction.

7. The front passenger seat airbag according to claim 1, wherein the pinching portion protrudes on an inner peripheral surface side of the outer peripheral wall.
